(19) United States
(12) Patent Application Publication
(10) Pub. No.: US 2020/0348165 A1
(43) Pub. Date: Nov. 5, 2020

(54) LUGGAGE RACK

(71) Applicant: Bruce Lambeth, Highland, CA (US)

(72) Inventor: Bruce Lambeth, Highland, CA (US)

(21) Appl. No.: 16/403,006

(22) Filed: May 3, 2019

(51) Int. Cl. G01G 19/52; G01G 21/28; G01G 23/37

(52) U.S. Cl. CPC G01G 19/52; G01G 23/3735; G01G 21/28

(57) ABSTRACT

An illustrated view of a luggage rack for weighing luggage is presented. The luggage rack is useful when a piece of luggage has been packed and is going to loaded onto an airplane, a train, or other vehicle. The luggage rack will present a real time view of a weight of the luggage and allow the owner to remove or add items to the luggage while receiving feedback on the weight from the luggage rack. The luggage rack has two rails where each of the two rails has a plurality of sensors. The sensors detect the weight of the luggage. The sensors are communicatively coupled to a display which receives the data from the sensors. The display determines a calculated weight from the received data and displays the weight on the display. A back rail is further disclosed which is coupled to the second rail. The back rail is useful for securing the luggage on a plurality of straps coupled to the two rails.

### FIELD OF THE INVENTION

This invention relates to luggage. More particularly, it relates to racks for luggage.

### BACKGROUND

Baggage or luggage consists of bags, cases, and containers which hold a traveler's articles while the traveler is in transit.

The modern traveler can be expected to have packages containing clothing, toiletries, small possessions, trip necessities, and on the return-trip, souvenirs. For some people, luggage and the style thereof is representative of the owner's wealth.

Luggage comes in various types, such as:

(a) Trunk—A wooden box, generally much larger than other kinds of luggage. Trunks come in smaller sizes as in the case of footlockers and larger ones called steamers. These days trunks are more commonly used for storage than transportation. Items large enough to require a trunk are now usually shipped in transport cases;

(b) Suitcase—A wheeled or non-wheeled luggage, as well as soft or hard side luggage;

(c) Garment bag—A style of luggage that folds over on itself to allow long garments such as suits or dresses to be packed flat to avoid creasing. Garment bags come in both wheeled and non-wheeled models, and are usually one of the largest pieces in any set of luggage;

(d) Tote—A small bag, usually worn on the shoulder: (e) Duffle bag—A barrel-shaped bag, almost exclusively soft side, is well suited to casual travel, with little organization inside.;

(f) Carpet bag—travel luggage traditionally made from carpets;

(g) Packing Cubes—Small rectangular bags of different sizes and different colors created to keep the baggage organized and save space; and

(h) Gate Check Bags—Bags specially designed to protect frequent gate checking items, such as strollers and car seats.

Racks are often used to store luggage. Luggage racks are normally dumb stands that provide no other use than to hold the luggage for some period of time. Therefore, there is a need for a smart luggage rack able to read the weight luggage.

### BRIEF DESCRIPTION OF THE DRAWINGS

FIG. 1 is illustrated view of an exemplary luggage rack.

FIG. 2 is an illustrated view of an exemplary back rail for the exemplary luggage rack shown in FIG. 1.

FIG. 3 is an illustrated end view of the exemplary luggage rack shown in FIG. 1.

FIG. 4 is an illustrated end view of the exemplary luggage rack shown in FIG. 1.

FIG. 5 is an illustrated top view of the exemplary luggage rack shown in FIG. 1.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

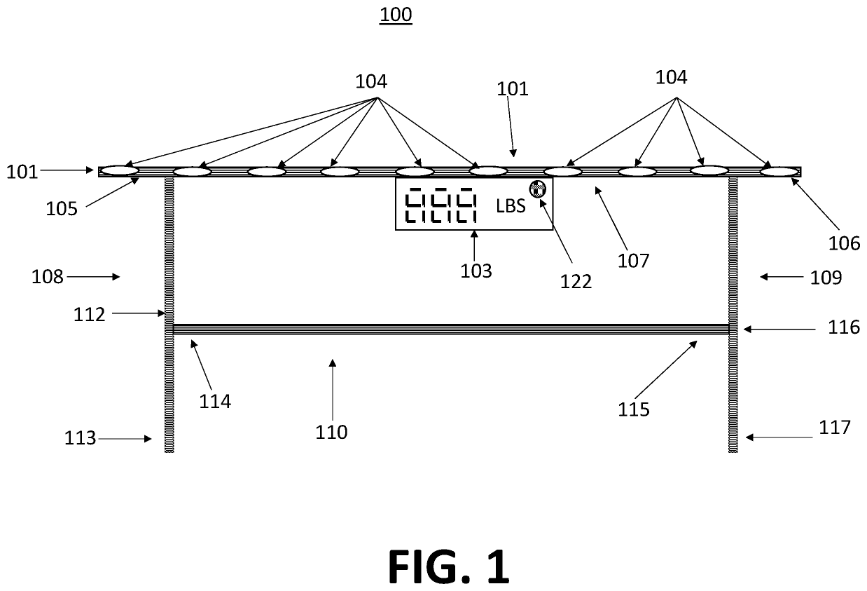

Referring to FIG. 1, an illustrated view of a luggage rack 100 for weighing luggage is presented. The luggage rack 100 is useful when a piece of luggage has been packed and is going to loaded onto an airplane, a train, or other vehicle. The luggage rack 100 will present a real time view of a weight of the luggage and allow the owner to remove or add items to the luggage while receiving feedback on the weight from the luggage rack 100.

The luggage rack 100 preferably has a height of twenty (20) inches, but other heights are hereby contemplated including, but not limited to, fifteen (15) inches, thirty (30) inches, ten (10) inches, thirty-three (33) inches, etc.

The luggage rack 100 preferably has a length of thirty-six (36) inches, but other heights are hereby contemplated including, but not limited to, twenty-two (22) inches, thirty (30) inches, twenty-five (25) inches, etc.

The luggage rack 100 preferably has a height of twenty (20) inches, but other heights are hereby contemplated including, but not limited to, fifteen (15) inches, thirty (30) inches, ten (10) inches, thirty-three (33) inches, etc.

The luggage rack 100 preferably has a shape being rectangular, but other shapes are hereby contemplated including, but not limited to, square, oblong, round, etc. The luggage rack 100 preferably is made of a wood material, but other materials are hereby contemplated including, but not limited to, metal such as steel, aluminum, etc., poly-vinyl chloride (PVC), high-density poly-ethylene (HDPE), hard-plastic, any combination of materials, etc.

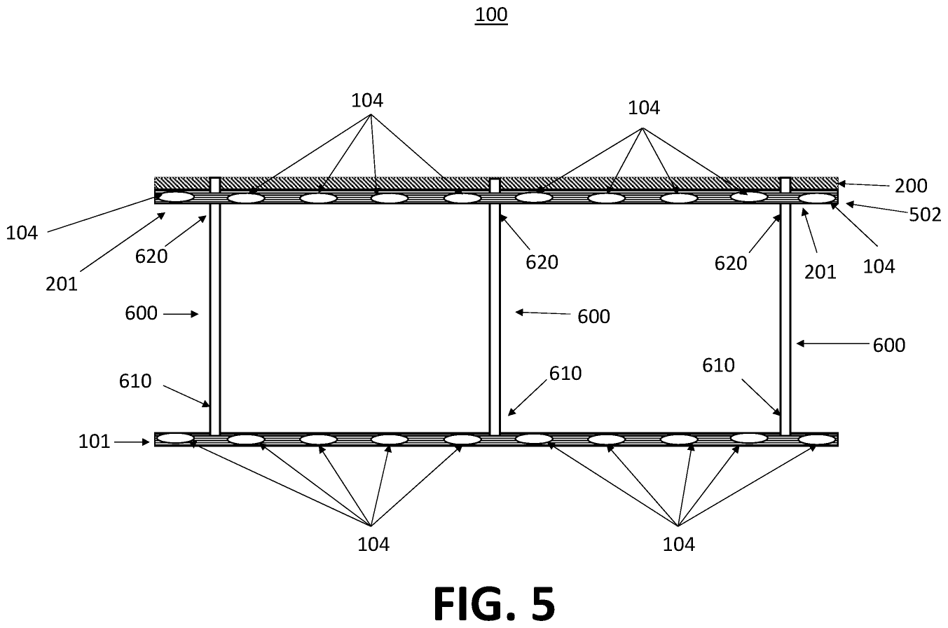

The luggage rack 100 has a first rail 101, a second rail (501 of FIG. 5), a display 103, and a plurality of sensors 104. The display 103 of the luggage rack 100 is preferably a light-emitting diode (LED) lit display, but other types of displays are hereby contemplated such as, but not limited to, cathode ray tube (CRT), liquid crystal display (LCD), etc.

The display 103 of the luggage rack 100 may have an actuator 122. The actuator 122 is preferably a button, but other types of actuators are hereby contemplated including, but not limited to, a toggle switch, a touch screen, a wireless connectivity to an application on a computing device, etc.

The first rail 100 has a first end 105, a second end 106 and a middle portion 107. The plurality of sensors 104 are coupled to the first rail 100 preferably substantially equally spaced but may be spaced differently as desired. The second rail 502 further has the plurality of sensors 104 securely coupled preferably substantially equally spaced but may be spaced differently as desired.

The plurality of sensors 104 securely coupled to the first rail 101 is preferably spaced the same as the plurality of sensors 104 securely coupled to the second rail 502, though it is contemplated that the plurality of sensors 104 securely coupled to the first rail 101 may be differently spaced than the plurality of sensors 104 securely coupled to the second rail 502.

The plurality of sensors 104 are communicatively coupled to the display 103. The display 103 receives a sensed data of the plurality of sensors 103 and determines a corresponding weight. The corresponding weight is thereby displayed on the display 103.

The luggage rack 100 further has a first leg 108, a second leg 109 and a support arm 110. The first leg 108 is securely and swivably coupled to the first end 105 of the first rail 101 and the second leg 109 is securely and swivably coupled to the second end 106 of the first rail 101. The second rail 502 is similarly configured as the first rail 101. The first leg 108 of the first rail 108 and a first leg 503 of the second rail 502 preferably intersect and create an “X” shape, but may be directly coupled to the ground. The second leg 109 of the first rail 108 and a second leg 504 of the second rail 502 preferably intersect and create an “X” shape, but may be directly coupled to the ground.

A first end 114 of the support arm 110 is securely coupled to between a middle portion 112 of the first leg 108 and a second end 113 of the first leg 108. A second end 115 of the support arm 110 is securely coupled to between a middle portion 116 of the second leg 109 and a second end 117 of the second leg 109.

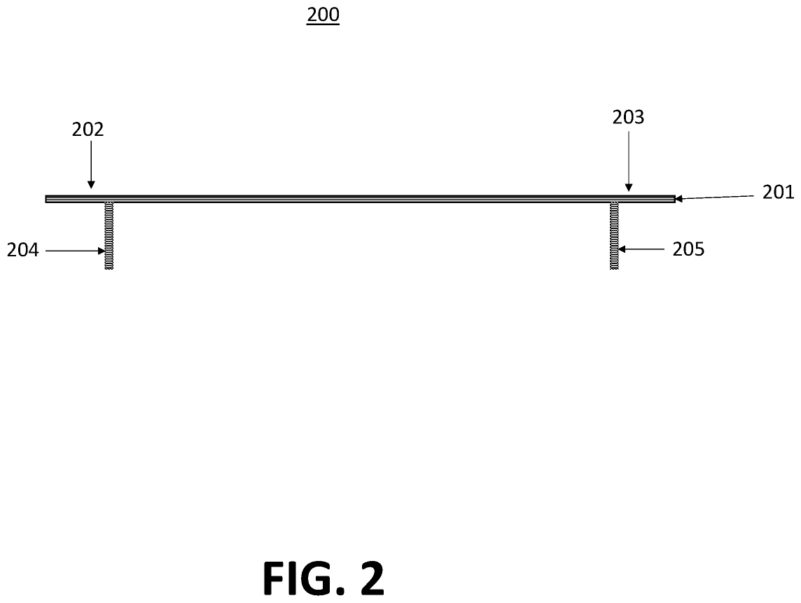

Moving now to FIG. 2, an optional and/or additional back rail 200 for adding additional safety and security to the luggage rack 100 is presented. The back rail 200 has a rail 201. The rail 201 has a first end 202 and a second end 203. A first support leg 204 is securely coupled to the substantially near the first end 202 of the rail 201. A second support leg 205 is securely coupled to substantially near the second end 203 of the rail 201.

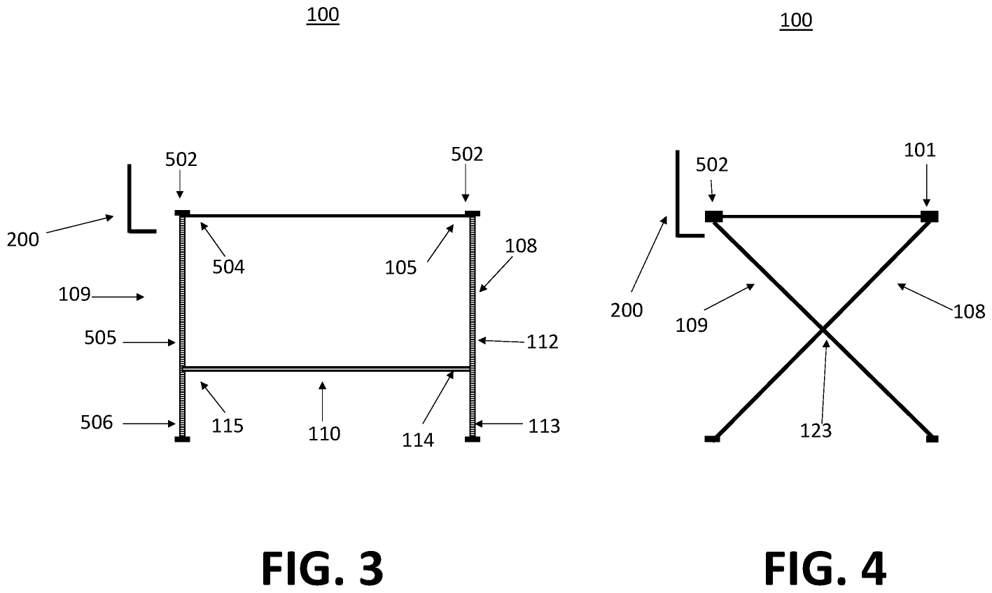

Referring now to FIG. 3, an illustrated side view of the luggage rack 100 shown is FIG. 1 where each of the legs 108,109 are straight perpendicular is presented. The side view shows the first leg 108 securely coupled to substantially near the first end 105 of the first rail 101 and the second leg 109 of the second rail 502 securely coupled to substantially near a first end 504 of the second rail 502.

The first end 114 of the support arm 110 is securely coupled to between the middle portion 112 of the first leg 108 and the second end 113 of the first leg 108. A second end 115 of the support arm 110 is securely coupled to between a middle portion 505 of the first leg 503 and a second end 506 of the second leg 109. The optional back rail 200 is shown being coupled to a back 505 of the second rail 502.

FIG. 4 illustrates a side view of the luggage rack 100 shown in FIG. 1 where the legs 108, 109 are crossed are presented.

The first leg 108 coupled to the first rail 101 is angled such that it intersected at substantially a center portion 111 of the first leg 108 is movably coupled 123 to the second leg 109 securely coupled to the second rail 502. The optional back rail 200 is shown being coupled to a back 505 of the second rail 502.

FIG. 5 illustrates a top view of the luggage rack 100 shown in FIG. 1. The first rail 101 and the second rail 502 are perpendicular. The optional back rail 200 is coupled to the back 505 of the second rail 502.

The plurality of sensors 104 are securely coupled to the first rail 101 and the second rail 502. The plurality of sensors 104 are equally spaced coupled to the first rail 101. The plurality of sensors 104 are equally spaced coupled to the second rail 502.

A first end 610 of each of a plurality of straps 600 are securely coupled to the first rail 101 are configured to be equal distance apart. A second end 620 of each of a plurality of straps 600 are securely coupled to the second rail 502 are configured to be equal distance apart. The plurality of straps 600 are useful in securely supporting the luggage placed on the luggage rack 100.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A luggage rack for weighing luggage, the luggage rack comprising:
a first rail and a second rail;
the first rail having a first leg and a second leg wherein the first leg of the first rail being coupled to a first end of the first rail, and wherein the second leg of the first rail being coupled to a second end of the first rail;
the second rail having a first leg and a second leg wherein the first leg of the second rail being coupled to a first end of the second rail, and wherein the second leg of the second rail being coupled to a second end of the second rail;
a plurality of straps, wherein each of the plurality of straps having a first end and a second end, wherein the first end of each of the plurality of straps being securely coupled to the first rail, and wherein the second end of each of the plurality of straps being securely coupled to the second rail; and
a plurality of sensors, the plurality of sensors being coupled to the first rail and coupled to the second rail, and wherein the plurality of sensors being communicatively coupled to a display.

2. The luggage rack of claim 1, wherein the luggage rack having a length of thirty-six (36) inches.

3. The luggage rack of claim 1, wherein the luggage rack having a height of twenty (20) inches.

4. The luggage rack of claim 1, wherein the luggage rack having a width of twenty (20) inches.

5. The luggage rack of claim 1, wherein the luggage rack being made of wood.

6. The luggage rack of claim 1, wherein the luggage rack being made of a metal material.

7. The luggage rack of claim 1, wherein the luggage rack being made of a combination of a wood material and a metal material.

8. The luggage rack of claim 1, wherein the display being an light-emitting diode (LED) display.

9. The luggage rack of claim 1, wherein the first leg of the first rail being straight.

10. The luggage rack of claim 1, wherein the first leg of the first rail being angled.

11. The luggage rack of claim 1, wherein the luggage rack further comprising: a support arm, a first end of the support arm being coupled to the first leg of the first rail, and wherein a second end of the support arm being coupled to the first leg of the second rail.

12. The luggage rack of claim 1, wherein the luggage rack further comprising: a back rail, the back rail being coupled to the second rail.
